(19) United States
(12) Patent Application Publication
(10) Pub. No.: US 2006/0111913 A1
(43) Pub. Date: May 25, 2006

(54) Audio encoding/decoding apparatus having watermark insertion/abstraction function and method using the same

(75) Inventor: Hyen O. Oh, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/280,418

(22) Filed: Nov. 17, 2005

(30) Foreign Application Priority Data
Nov. 19, 2004 (KR) 10-2004-0095120

(51) Int. Cl. G10L 11/00

(52) U.S. Cl. 704/274

(57) ABSTRACT

Disclosed herein are an audio encoding/decoding apparatus having a watermark insertion/abstraction function capable of inserting/abstracting watermark information into/from a bit stream in a digital audio and image encoding process, and a method using the same. The high sound-quality audio encoding apparatus includes: a bit allocation unit for allocating a bit to each sub-band using an SMR (Signal to Mask Ratio) value of each sub-band in an inputted audio signal; a quantization unit for quantizing each sub-band sample in the inputted audio signal according to the number of bits allocated through the bit allocation unit; a watermark insertion unit for inserting watermark data in a location of the quantized sub-band sample in the sub-band in which the bit is not allocated, and encoding the watermark-inserted sub-band sample; and a bit stream generation unit for converting the quantized sub-band sample, the watermark-inserted sub-band sample, scale factor information and bit allocation information into a format of an audio bit stream, and transmitting the format-converted audio bit stream.

This application claims the benefit of Korean Patent Application No. 10-2004-0095120, filed on Nov. 19, 2004, which is hereby incorporated by reference as if fully set forth herein.

### BACKGROUND OF THE INVENTION

1. Field

The present invention relates to digital watermarking among data concealment methods, and more particularly to an audio encoding/decoding apparatus having a watermark insertion/abstraction function capable of inserting/abstracting watermark information, and a method using the same.

2. Discussion of the Related Art

Generally, watermarking refers to embedding secret information, referred to as a “watermark” into a medium such as video, image, audio and text. Extraction of the embedded watermark information can be limited to those who know it. Common users are incapable of distinguishing watermarked media from general media.

Specifically, a digital medium brings about a new issue of copyright protection, due to its advantages as compared with an analogous medium, in that access, transmission, editing and storage are easy and data degradation is not caused at the time of data distribution through an electric wave or a communication network. Digital watermarking is noted as a means for preventing copyright infringement.

Digital watermarking is not only used for inserting information to distinguish a proprietor to protect a copyright, but is also used for inserting control information for copy-protection, distribution confirmation, broadcasting monitoring and the like or is used for inserting information such as presentation time control information, synchronization (Lip-sync), content information and lyrics into a real time medium such as audio, video and the like and transmitting the inserted information.

As such, digital watermarking has different characteristics depending on the function thereof, but imperceptibility and robustness are no doubt essential.

The imperceptibility being the most basic requirement means that an original medium and a watermark inserted medium are indistinguishable from one another when users view or listen to them.

Robustness means that even though the watermark inserted medium is as altered, for example though filtering, compression, noise addition and degradation required for distribution and transmission, the inserted watermark is preserved.

Specifically, a watermark for copyright protection and the copy-protection should be robust so that it can cope with an intentional attack intended to eliminate the watermark. Meanwhile, a watermark for forgery identification is easily extinguished when it is deformed or manipulated.

Further, a watermark for embedding additional information such as presentation time control information, lip-sync, content information and lyrics into the medium has a relatively low robustness against intentional attack or distortion.

FIG. 1 is a schematic view showing a general digital watermark insertion/abstraction system.

As shown in FIG. 1, watermark data is embedded into a digital medium (audio, video, image, text and the like) using a watermark insertion system 110. At this time, a secret or public key for security can be additionally used depending on a watermarking algorithm.

After that, the inserted watermark can be extracted from a watermark inserted medium by using a watermark extraction system 130. At this time, an original medium can be required depending on the watermark algorithm, and decoding can also be performed using only the public key required at the time of insertion.

A system not requiring the original medium in a watermark extraction process is called “blind watermarking”.

Among watermarking methods, an audio signal watermarking method is variously exemplified such as a Least Significant Bit (LSB) encoding method, an echo hiding method, and a spread spectrum communication method and the like.

In the LSB encoding method, least significant bits of a quantized audio sample are deformed to insert desired information. The LSB encoding method uses a characteristic in which the deforming of the least significant bit of an audio signal has almost no influence upon sound quality. The LSB encoding method has an advantage in that insertion and abstraction are simply performed and the sound quality is less distorted, but has a drawback in that it is vulnerable to signal processing such as loss compression or filtering.

Further, in the echo hiding method, an inaudible echo is inserted into an audio signal. That is, the echo hiding method inserts and encodes an echo with a different time delay into the audio signal, which is subdivided at a predetermined interval, depending on binary watermark information to be inserted. In a decoding process, binary information is decoded by detecting an echo time delay at each of subdivided durations. In this case, the inserted signal is not noise, but is the audio signal itself having the same characteristics as an original signal. Therefore, even though the inserted signal is heard, the inserted signal is not recognized as a distorted signal. The inserted signal is rather expected to provide a better tone. Accordingly, the echo hiding method is suitable for high quality audio watermarking, but has a disadvantage in that since the detection is performed using a Cepstrum operation, the method is computationally intensive, and in case where the synchronization for the duration to be subdivided at a time-domain is missed, the decoding is not performed.

Further, the spread spectrum communication method is a typical watermarking method, which is popularized for video watermarking and most studied even for audio watermarking. In the spread spectrum communication method, an audio signal is transformed into a frequency signal through a discrete Fourier transformation and then, binary watermark information is spectrum-spread to a PN (Pseudo Noise) sequence to insert spread information into the frequency-transformed audio signal. An inserted watermark can be detected using a correlator taking advantage of a high auto-correlation characteristics of the PN sequence, and has a characteristic of robustness against interference and excellent encryption. On the contrary, the spread spectrum communication method has a drawback in that sound quality is deteriorated, insertion and abstraction are computationally intensive, and compression encoding is incomplete when the watermark has a high intensity to improve robustness.

As such, summarizing conventional audio watermarking, conventional audio watermarking has a drawback in that its implementation method is complex since the watermark information is generally inserted into the original signal before the original signal is compressed and decoded, and accordingly is computationally intensive and the original signal is easily deformed when it is compressed.

### SUMMARY OF THE INVENTION

Accordingly, the present invention is directed to an audio encoding/decoding apparatus having a watermark insertion/abstraction function and a method using the same that substantially obviate one or more problems due to limitations and disadvantages of the related art.

An object of the present invention is to provide an audio encoding/decoding apparatus having a watermark insertion/abstraction function and a method using the same, wherein, by inserting a watermark into a bit stream during a digital audio and image compression-coding process, it is possible to easily insert and abstract watermark data, and it is possible to prevent distortion of an original audio signal and the inserted watermark.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a high sound-quality audio encoding apparatus includes: a bit allocation unit for allocating a bit to each sub-band using an SMR (Signal to Mask Ratio) value of each sub-band in an inputted audio signal; a quantization unit for quantizing each sub-band sample in the inputted audio signal according to the number of bits allocated through the bit allocation unit; a watermark insertion unit for inserting watermark data in a location of the quantized sub-band sample in the sub-band in which the bit is not allocated, and encoding the watermark-inserted sub-band sample; and a bit stream generation unit for converting the quantized sub-band sample, the watermark-inserted sub-band sample, scale factor information and bit allocation information into a format of an audio bit stream, and transmitting the format-converted audio bit stream.

Preferably, the watermark insertion unit sets the scale factor of the sub-band in which the watermark data are inserted, to 0 or a value close to 0.

In another aspect of the present invention, a high sound-quality audio decoding apparatus includes: a bit stream abstraction unit for abstracting a quantized sub-band sample, a watermark-inserted sub-band sample, bit allocation information and scale factor information from a compression-transmitted audio bit stream; a watermark abstraction unit for abstracting watermark data from the watermark-inserted sub-band sample using the bit allocation information and scale factor information abstracted from the bit stream abstraction unit, and outputting the abstracted watermark; a de-quantization unit for de-quantizing the quantized sub-band sample using the bit allocation information and scale factor information abstracted from the bit stream abstraction unit; and a filter bank for converting the de-quantized sub-band sample though the de-quantization unit into a time-domain sample, and outputting a resulting decoded audio signal.

In another aspect of the present invention, a high sound-quality audio encoding method includes the steps of: a) encoding an inputted audio signal into a plurality of sub-band samples, and allocating a bit to each sub-band; b) quantizing each of the encoded sub-band samples according to the number of allocated-bits; c) inserting watermark data into a location of the sub-band sample in which the bit is not allocated, among the quantized sub-band samples, and encoding the watermark-inserted sub-band sample; and d) converting the quantized sub-band sample, the watermark-inserted sub-band sample, scale factor information and bit allocation information into a format of an audio bit stream, and transmitting the format-converted audio bit stream.

In another aspect of the present invention, a high sound-quality audio decoding method includes the steps of: a) abstracting a quantized sub-band sample, a watermark-inserted sub-band sample, bit allocation information and scale factor information from a compression-transmitted audio bit stream; b) abstracting watermark data from the corresponding sub-band using the bit allocation information of the sub-band in which the watermark data is inserted, and outputting the abstracted watermark; c) de-quantizing the quantized sub-band sample using the bit allocation information and scale factor information of the corresponding sub-band; and d) converting the de-quantized sub-band sample into a time-domain sample, and outputting a resulting decoded audio signal.

Accordingly, the present invention can abstract the watermark information and simultaneously decode an audio signal with respect to the watermark-inserted bit stream, and can decode a conventional MPEG bit stream into which the watermark is not inserted. In addition, the present invention is capable of decoding the watermark-inserted MPEG bit stream with no distortion through the conventional MPEG decoder.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view showing a general digital watermark insertion/abstraction system;

FIG. 2 is a bock diagram illustrating the configuration of a general MPEG audio encoder;

FIGS. 3 is a view illustrating various relations between a general sub-band sample and a scale factor;

FIG. 4 is a view illustrating an AAU structure of a general MPEG audio bit stream;

FIG. 5 is a block diagram illustrating the configuration of a general MPEG audio decoder;

FIG. 6 is a schematic view illustrating a high sound-quality audio encoder and decoder in which a digital water mark insertion and abstraction apparatus is embedded according to the present invention;

FIG. 7 is a block diagram illustrating the configuration of a high sound-quality audio encoding apparatus including a watermark insertion unit according to an embodiment of the present invention;

FIG. 8 is a block diagram illustrating the configuration of a high sound-quality audio decoding apparatus including a watermark abstraction unit according to an embodiment of the present invention;

FIG. 9 is a view illustrating various examples wherein a watermark is inserted into a quantized sub-band sample area according to the present invention; and

FIG. 10 is a view illustrating an AAU structure of an MPEG audio bit stream in which a watermark is inserted according to the present invention.

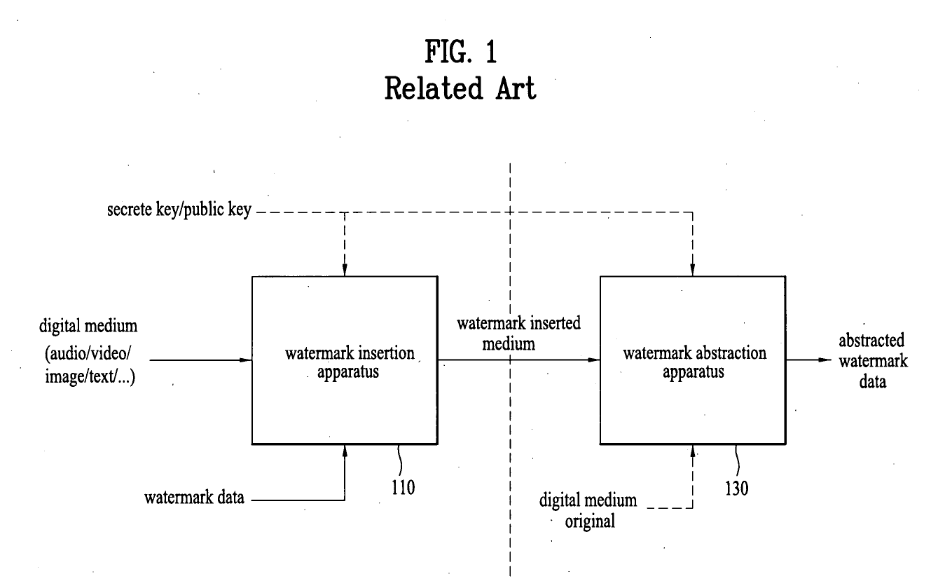

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

In the specification, the same or similar elements are denoted by the same reference numerals even though they are depicted in different drawings, and a detailed description thereof will thus be omitted because it is considered to be unnecessary.

Prior to describing the present invention, it should be noted that most terms disclosed in the present invention correspond to general terms well known in the art, but some terms have been selected by the applicant as necessary and will hereinafter be disclosed in the following description of the present invention. Therefore, it is preferable that the terms defined by the applicant be understood on the basis of their meanings in the present invention.

The present invention discloses an apparatus and method for inserting and abstracting a watermark by modifying a part of an MPEG audio encoding and decoding method.

An MPEG audio decoding apparatus having a watermark abstraction function according to the present invention is capable of abstracting watermark information and simultaneously decoding an audio signal with respect to a watermark-inserted bit stream. In addition, the MPEG audio decoding apparatus is capable of decoding a conventional MPEG audio bit stream in which a watermark is not inserted.

In addition, an MPEG audio bit stream in which the watermark is inserted according to the present invention is capable of decoding a signal without distortion through a conventional MPEG audio decoder. Herein, the conventional MPEG audio decoder cannot perceive whether the watermark is inserted.

Prior to describing insertion and abstraction operations of the watermark in the MPEG audio encoding and decoding processes according to the present invention, the general MPEG audio encoding and deciding apparatus will be described for a better understanding of the present invention.

Generally, an MPEG audio standard contains a total of three modes referred to as first to third layers. The higher layer is capable of accomplishing high quality and high compression, while it increases hardware size. That is, the first layer has characteristics such as a bit rate of 256 Kbps, 32 sub-bands, bit allocation, a scale factor, and 384 samples per frame. The second layer has characteristics such as a bit rate of 193 Kbps, 32 sub-bands, bit allocation, a scale factor, and 1152 samples of three parties per frame. In addition, the third layer has characteristics such as a bit rate of 128 Kbps, a hybrid filter bank, bit allocation, a scale factor, 1152 samples per frame, Huffman encoding, and Entropy encoding.

In addition, the MPEG audio encoding apparatus, identical to other high sound-quality audio encoding technologies, uses a psychoacoustics model based on aural characteristic with respect to ears in order to remove perceptual redundancy in audio signals, and has a structure which it is combined with a conventional data compression algorithm in order to remove statistical redundancy in audio signals.

According to an embodiment of the present invention, the second layer among the three layer MPEG audio modes will be described.

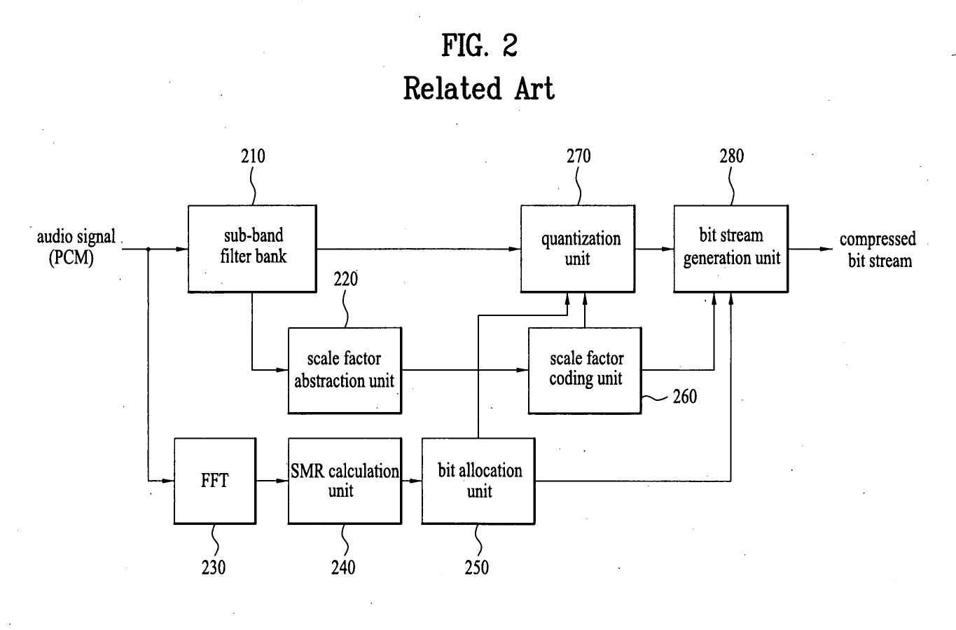

FIG. 2 is a bock diagram illustrating the configuration of a general MPEG audio encoder, for example, the MPEG 2 layer audio encoding apparatus.

To begin with, a PCM (Pulse encode Modulation) type audio signal is inputted to a sub-band filter bank 210 and a FFT (Fast Fourier Transform) unit 230.

The sub-band filter bank 210 removes the statistical redundancy of the audio signal, and outputs the audio signal to a quantization unit 270. The FFT unit 230 converts the inputted audio signal into an audio signal of frequency domain, and outputs the audio signal of frequency domain to an SMR (Signal to Mask Ratio) calculation unit 240.

In order to effectively use the aural characteristics, it is required that the audio signal be divided into frequency components. Thus, the sub-band filter bank 210 subdivides an entire band into 32 sub-bands with even frequency interval, and encodes the sub-bands of the inputted audio signal. That is, when the audio signal passes through 32 pieces of the even interval filter bank 210 which adopts a Weighted Overlap-Add algorithm, the audio signal is encoded to the sub-band sample, and thereby statistical redundancy is eliminated.

The FFT unit 230 converts the inputted audio signal into an audio signal of frequency domain through FFT, and outputs the converted frequency signal to the SMR calculation unit 240. That is, the psychoacoustics model using FFT acquires a masking threshold value of a noise level which is inaudible from the FFT-processed frequency signal so as to remove the perceptual redundancy in audio signals, and calculates an SMR value for each sub-band on the basis of the masking threshold value. Then, frequency spectrum converted by the FFT unit 230 and the scale factor abstracted from the scale factor abstraction unit 220 are inputted to the SMR calculation unit 240. In addition, the scale factor abstracted from the scale factor abstraction unit 220 is encoded by the scale factor encoding unit 260, and then is outputted to the quantization unit 270 and a bit stream generation unit 280.

Herein, a ‘masking’ phenomenon which is an important characteristic of sound perception is referred to as a phenomenon that low sound below a specific threshold value is hided by loud sound, that is, a phenomenon that loud sound suppresses perception of low sound. A frequency masking phenomenon represents a case that two sounds coexist. That is, when an unmixed sound with a specific frequency may mask another sound with a different frequency, the frequency masking causes the masked sound having energy above a specific threshold value to be audible. Herein, the specific threshold value is referred to as a masking threshold which is different from an absolute threshold. The absolute threshold is a threshold value capable of perceiving any sound.

On the other hand, when the SMR value calculated through the SMR calculation unit 240 is inputted to the bit allocation unit 250, the bit allocation unit 250 allocates a minimum bit to each sub-band sample using the SMR value so that quantization noise is masked, and outputs the bit-allocated sub-band sample to the quantization unit 270 and the bit stream generation unit 280. That is, in the dynamic bit allocation process, the bit allocation unit 250 allocates the bit to each sub-band so that the quantization noise is masked by a signal on the basis of the SMR value.

The quantization unit 270 divides each sub-band sample outputted through the filter bank 210 by a scale factor encoded through the scale factor encoding unit 260 so that each sub-band sample is normalized, quantizes the normalized sub-band sample according to the number of allocated bit, and outputs the quantized sub-band sample to the bit stream generation unit 280.

The bit stream generation unit 280 converts the quantized sub-band sample, the bit allocation information outputted through the bit allocation unit 250, and the scale factor information outputted through the scale factor encoding unit 260 into a bit stream format defined by the MPEG standard, and transmits the format-converted bit stream.

That is, in the MPEG audio encoding apparatus, the sub-band sample converted into the frequency domain is divided into the scale factor as a size factor and the normalized sample value, and the sub-band sample of the bit stream form is transmitted. Generally, a frequency spectrum is divided into a normal spectrum coefficient group which is referred to as a scale factor band. This spectrum coefficient is called to one scale factor, wherein the scale factor is used to change amplification of all spectrum coefficients in the spectrum factor band.

The sub-band sample may be described as following equation 1:
x(i)=scf(b)*ix(i) [equation 1]
x(i): sub-band sample
scf(b): scale factor of each sub-band
ix(i): normalized sub-band sample
i: sub-band sample index
b: sub-band index

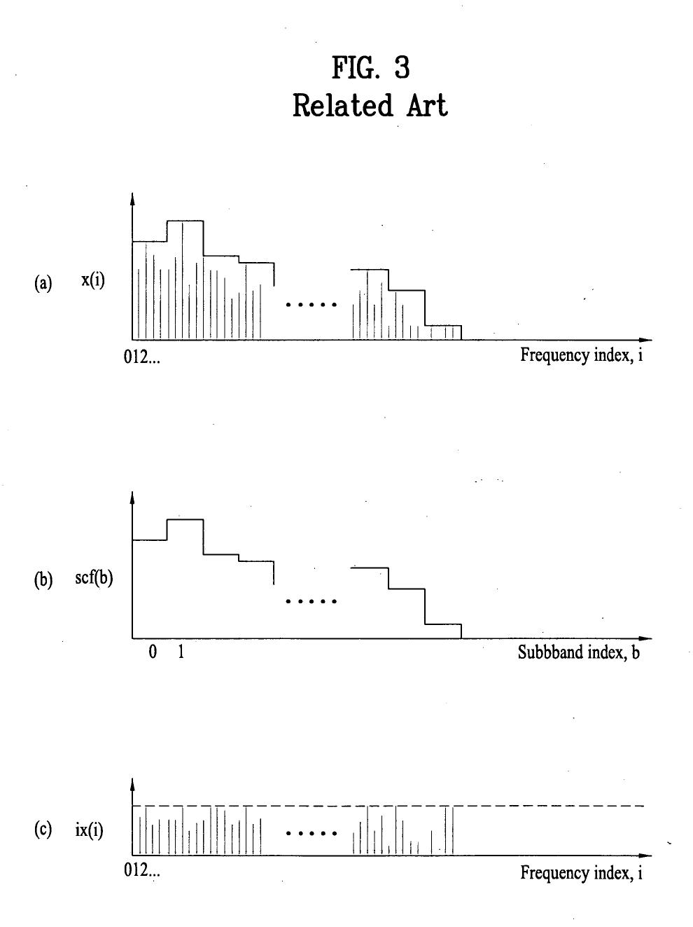

FIG. 3 is a view illustrating various relations between a general sub-band sample and a scale factor, that is, FIG. 3 shows that the sub-band sample (a) is divided into the scale factor for each sub-band (b) and the normalized sub-band sample (c) according to equation 1.

Herein, the scale factor abstraction unit 220 abstracts a total of 96 scale factors by threes for each sub-band. However, in actual transmission of the bit stream, the above scale factor value is not transmitted. Instead, a 6-bit scale factor index is transmitted. Then, the sub-band sample normalized by the scale factor is quantized according to the number of allocated bit for each sub-band, and the quantized sub-band sample of the form of the bit stream is transmitted.

This scale factor encoding process is a component of sample data encoding for each band. In this scale factor encoding process, similar sample data values of a corresponding band are collected, and the quantization noise occurrence is suppressed, and thereby the noise is not perceived by affecting an aural-related psychological effect. The aural-related psychological effect mainly relates to a minimum audible threshold effect and masking effect. Due to the masking effect, the bit is not allocated to an unperceivable frequency band.

In the MPEG 2 layer audio encoding, in order to decrease the amount of transmission of the scale factor index, it uses a method for transmitting 1 to 3 patterns in which the scale factors are different according to scale factor selection information (SCFSI). For example, by determining whether 3 scale factor indexes which are calculated in one sub-band are similar, if similar, it may transmit 1 representative value, and if not similar, it may transmit respective values. In addition, with reference to the bit allocation information for each sub-band, with respect to the sub-band in which the bit is not allocated, it does not transmit the normalized sub-band sample, the scale factor selection information (SCFSI) and the scale factor index.

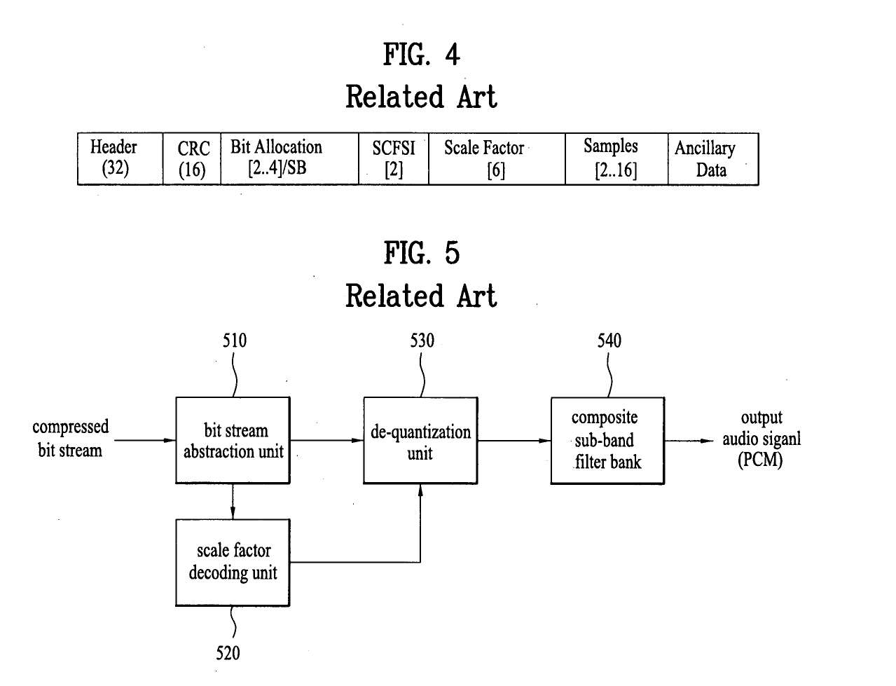

FIG. 4 is a view illustrating an AAU structure of a general MPEG audio bit stream, and schematically shows a form of the MPEG 2 layer audio bit stream which is transmitted through the bit stream generation unit 280.

That is, the MPEG audio bit stream is composed of an AAU (Audio Access Unit) Herein, the AAU is a minimum unit capable of individual decoding, in which data of predetermined samples are always compressed and stored. As shown in FIG. 4, the AAU is composed of a header, a CRC (Cyclic Redundancy Check) bit, the bit allocation information, the scale factor selection information, the scale factor index information, compression-coded sub-band sample data, and auxiliary data. Herein, the auxiliary data is referred to as data which are stored in the remaining portion of the AAU when an end portion of the audio sample data does not arrive at an end portion of the AAU, wherein any data except for the MPEG audio data may be inserted in the remaining portion of the AAU.

FIG. 5 is a block diagram illustrating the configuration of a general MPEG audio decoder. A decoding process of the MPEG audio signal is contrary to the encoding process of the MPEG audio signal as shown in FIG. 3

To begin with, a bit stream abstraction unit 510 abstracts required information such as header information, bit allocation information, scale factor selection information, a scale factor index, a quantized sub-band sample, etc. from the bit stream compressed and transmitted through the MPEG audio encoding apparatus, and outputs the abstracted information to a scale factor decoding unit 520 and a de-quantization unit 530. Herein, the scale factor decoding unit 520 decodes the scale factor on the basis of the abstracted information, and outputs the decoded scale factor to the de-quantization unit 530.

The de-quantization unit 530 restores the sub-band sample by applying the decoded scale factor and the bit allocation information into the above equation 1, and then outputs the restored sub-band sample to a composite sub-band filter bank 540. Next, the composite sub-band filter bank 540 converts the sub-band sample into 32 time domain samples, and outputs the resulting decoded audio signal.

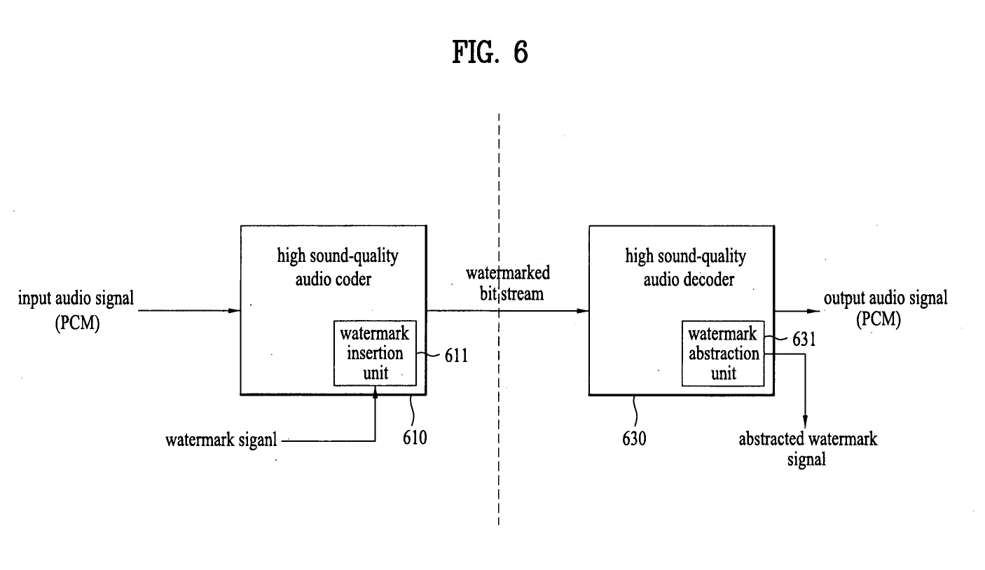

FIG. 6 is a schematic view illustrating a high sound-quality audio encoder and decoder in which a digital water mark insertion and abstraction apparatus is embedded according to the present invention.

More particularly, according to an embodiment of the present invention, a case wherein a watermark insertion and abstraction apparatus is embedded in the above-described MPEG 2 layer audio encoding and decoding apparatus as shown in FIGS. 2 and 5 will be described as follows.

Referring to FIG. 6, a high sound-quality audio encoder 610 for performing audio encoding and watermark insertion receives a high sound-quality audio signal for compression-coding and watermark information for inserting, and performs both audio encoding and watermark encoding. Herein, by modifying a part of a conventional high sound-quality audio encoder, the watermark is inserted by a watermark insertion unit 611.

In addition, a high sound-quality audio decoder 630 for performing audio decoding and watermark abstraction abstracts the watermark by modifying a part of a conventional high sound-quality audio decoder for decoding the compressed bit stream and restoring an original audio signal. Herein, even conventional high sound-quality audio decoder which does not include the watermark abstraction apparatus may normally decode the audio bit stream and acquire an output audio signal (PCM).

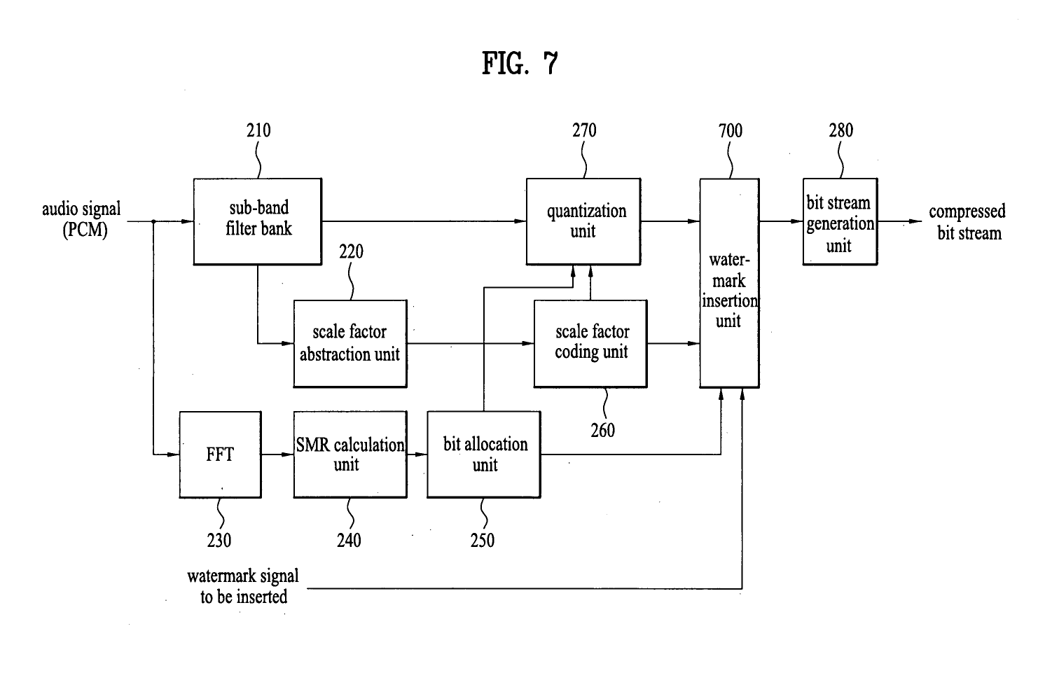

FIG. 7 is a block diagram illustrating the configuration of a high sound-quality audio encoding apparatus including a watermark insertion unit according to an embodiment of the present invention.

Referring to FIG. 7, the watermark insertion unit 700 according to the present invention is added to output terminals of the quantization unit 270 and the scale factor encoding unit 260 of the high sound-quality audio encoder as shown in FIG. 2. That is, by modifying the scale factor encoding process among the conventional high sound-quality audio encoding process, prior to generating the bit stream, the watermark is inserted. Herein, the audio bit stream, into which the watermark generated through the bit stream generation unit 280 is inserted, is no different from conventional audio bit stream.

Now, referring to FIG. 7, the watermark insertion process in the high sound-quality audio encoding process will be described.

The watermark insertion unit 700 conceals the watermark in the quantized sub-band sample of the sub-band in which the bit is not allocated, among the 32 sub-bands in the bit allocation process.

For example, as shown in FIG. 3, since there is no signal in the sub-band corresponding to a high frequency band, the scale factor is 0, and the sub-band sample value after quantization is 0. That is, the bit allocation unit 250 does not allocate the bit to the sub-band.

Thus, the watermark insertion unit 700 remains the scale factor to 0 or a value close to 0, and arranges the watermark data into a place of corresponding sub-band sample so as to encode the watermark-inserted sub-band sample. Then, the high sound-quality audio encoder can read the watermark value according to equation 1, but the watermark has no effect on the actual decoded audio signal. That is, perceptively, the watermark-inserted bit stream is not different from the bit stream in which the watermark is not inserted.

For example, in the case of the MPEG 2 layer audio encoding method, the smallest value among the transmitted scale factor index is 0.0000012. Herein, the value is smaller by −286 dB than the largest value, and the value is small by −143 dB in comparison with intermediate scale factor index 0.00155. Thus, the corresponding sub-band generates a signal which is inaudible.

FIG. 9 is a view illustrating various examples wherein a watermark is inserted into a quantized sub-band sample area according to the present invention. FIG. 9 shows that the sub-band sample (a) is divided into the scale factor for each sub-band (b) and the normalized sub-band sample (c).

In order words, FIG. 9 shows an example that the watermark is inserted to a k-th sub-band in which the bit is not allocated. Herein, the scale factor of the k-th sub-band remains 0 or a value closed by 0.

That is, in order to insert the watermark signal, the bits are allocated to the corresponding sub-band in which any bit is not allocated according to the number of watermark bits. According to the MPEG standard, since one sub-band is composed of 36 sub-band samples, for example, when 3 bits are allocated to the corresponding sub-band, the watermark information corresponding to a bit length of 108 bits may be inserted. In the sub-band in which the bits are allocated to insert the watermark, the scale factor is set to a value close to 0, and then the watermark data represented in a form of a binary bit stream are inserted in the sub-band sample area. As a result, the bit allocation information may be set according to the amount of the watermark data, and the watermark may be inserted in one or more sub-band in one frame.

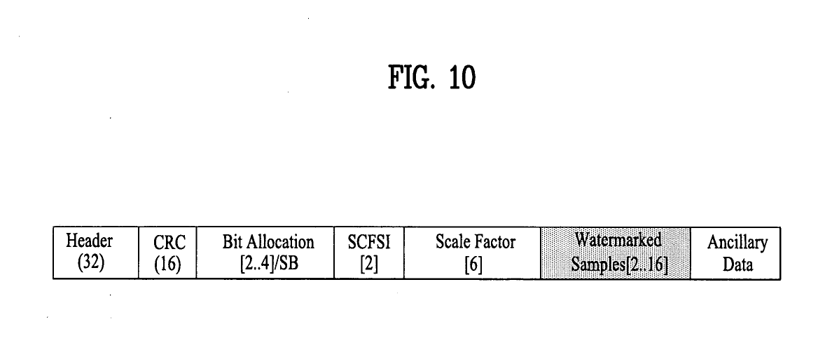

In addition, the watermark insertion unit 700 outputs the quantized sub-band sample including the above watermark-inserted sub-band sample, to the bit stream generation unit 280. The bit stream generation unit 280 generates an audio bit stream as shown in FIG. 10, and transmits the generated audio bit stream.

FIG. 10 is a view illustrating an AAU structure of an MPEG audio bit stream in which a watermark is inserted according to the present invention. FIG. 10 schematically shows a format of the MPEG 2 layer audio bit stream in which the watermark transmitted through the bit stream generation unit 280 is inserted.

As shown in FIG. 10, the AAU bit stream according to the present invention is composed of a header, a CRC (Cyclic Redundancy Check) bit, the bit allocation information, the scale factor selection information, the scale factor index information, sub-band sample data including the watermark-inserted sub-band, and auxiliary data.

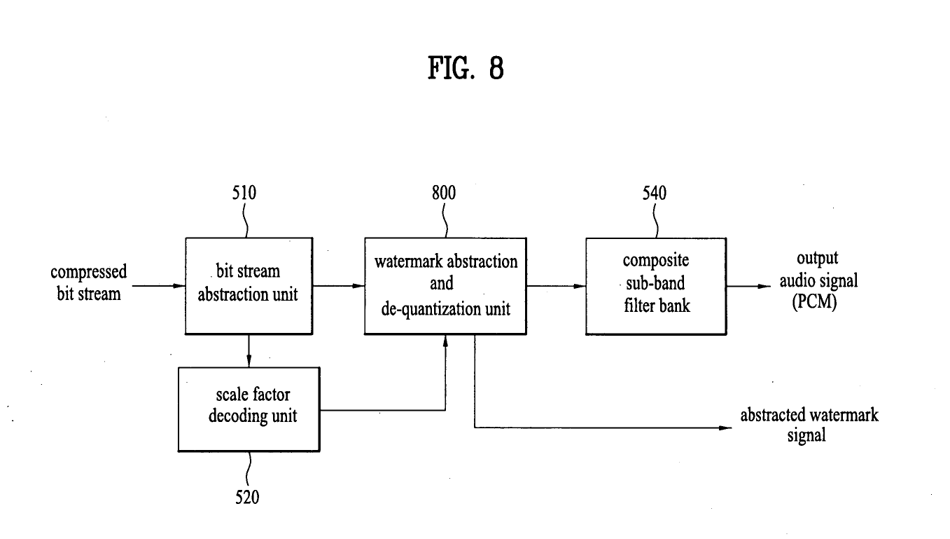

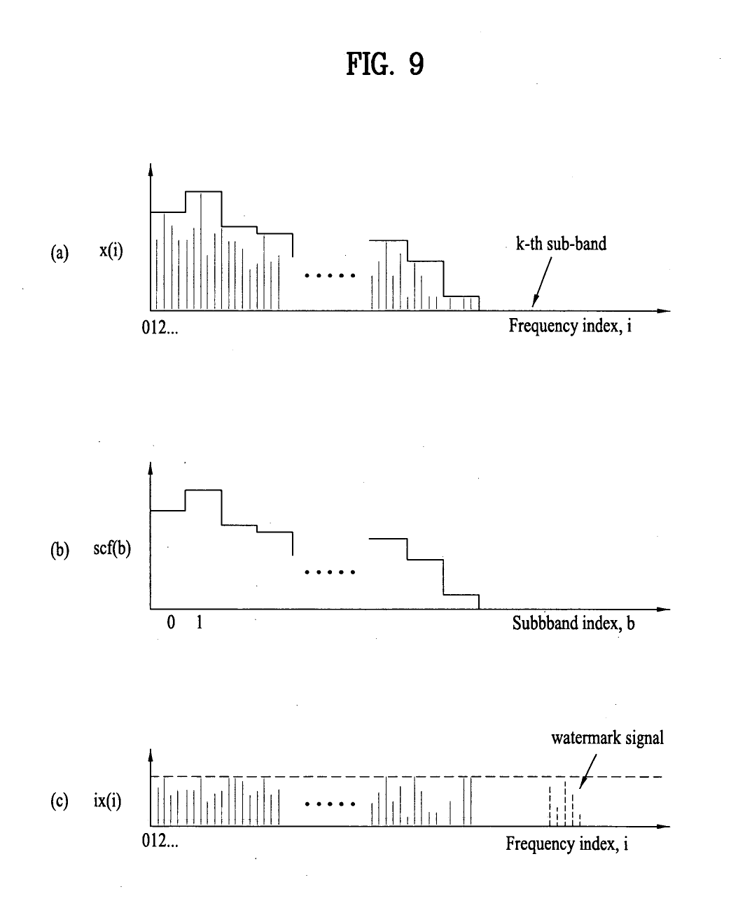

FIG. 8 is a block diagram illustrating the configuration of a high sound-quality audio decoding apparatus including a watermark abstraction unit according to an embodiment of the present invention.

To begin with, a bit stream abstraction unit 510 abstracts required information such as header information, bit allocation information, scale factor selection information, a scale factor index, a quantized sub-band sample, etc. from the bit stream compressed and transmitted through the MPEG audio encoding apparatus, and outputs the abstracted information to the scale factor decoding unit 520 and a watermark abstraction and de-quantization unit 800. Herein, the scale factor decoding unit 520 decodes the scale factor of the corresponding sub-band on the basis of the abstracted scale factor selection information and scale factor index information, and outputs the decoded scale factor to the watermark abstraction and de-quantization unit 800.

The watermark abstraction and de-quantization unit 800 abstracts a binary watermark using the decoded scale factor and bit allocation information prior to the de-quantization.

Herein, the watermark abstraction and de-quantization unit 800 determines whether the quantized sub-band sample is the watermark-inserted sub-band sample or the normal audio signal-inserted sub-band sample using the scale factor index information. If the quantized sub-band sample is the watermark-inserted sub-band sample, the watermark abstraction and de-quantization unit 800 abstracts the binary watermark using the bit allocation information of the corresponding sub-band.

Then, the watermark abstraction and de-quantization unit 800 restores each sub-band sample by plugging the decoded scale factor and the bit allocation information into the above equation 1, and then outputs the restored sub-band sample to the composite sub-band filter bank 540. Herein, even though the scale factor value of the watermark-inserted sub-band sample is de-quantized, the scale factor value is 0 or a value close to 0 since the scale factor value is 0 or a value close to 0. Thus, the watermark is not outputted as the audible sound. In addition, in the general high sound-quality audio decoder having no watermark abstraction unit, since the scale factor is 0 or a value close to 0, it cannot detect whether the watermark is inserted. That is, even though the watermark-inserted sub-band is decoded, it generates an audio signal which is inaudible.

Next, the composite sub-band filter bank 540 converts the de-quantized sub-band sample into 32 time domain samples, and outputs the resulting decoded audio signal.

The embodiment of the present invention was described on the basis of the above MPEG 2 layer audio encoding method among high sound-quality audio encoding methods, but it is to be understood that any audio and image encoding method for dividing information to be transmitted into the actual sample and a size factor such as the scale factor and generating the bit stream is broadly applied according to the above principle of the invention.

In the high sound-quality audio and image decoding method as noted the above, with respect to a particular case that the scale factor and the quantized sample are divided and transmitted, when inserting the watermark information in the quantized sample of the bit stream, it is possible to generate a bit stream which is compatible with conventional decoders. In addition, it is possible to abstract additional watermark information which is different from an original signal using the encoder capable of abstracting the watermark information. In addition, since the watermark information may be copyright information with respect to corresponding content, it is possible to use the watermark information for copyright protection and to employ the watermark information for controlling access operations such as decoding, copying, and reproduction or the like. In addition, it is possible to use when identification information for monitoring, synchronizing information between audio signal and video signal, and additional information such as title, lyrics, and caption, etc. are transmitted. That is, it is possible to remain flexibility with conventional decoders and simultaneously acquire additional information transmission channels. In addition, when the watermark abstraction method is provided to a specific person, it is possible to use the corresponding watermark in order for private communication.

As apparent from the above description, the present invention provides an audio encoding/decoding apparatus having a watermark insertion/abstraction function and a method using the same, wherein, it is possible to conceal inaudible watermark information using bit stream in quantized sample which is transmitted in an encoding process of a digital audio and image signal, and to effectively insert and abstract the watermark in compression-coding and decoding processes. That is, the MPEG audio decoding apparatus having the watermark abstraction function can abstract the watermark information and simultaneously decode an audio signal with respect to the watermark-inserted bit stream, and can decode a conventional MPEG bit stream in which the watermark is not inserted.

In addition, the present invention provides an audio encoding/decoding apparatus having a watermark insertion/abstraction function and a method using the same capable of decoding the watermark-inserted MPEG bit stream without distortion through conventional MPEG decoder, wherein, since the conventional MPEG decoder cannot perceive whether the watermark is inserted, it is possible to remain the flexibility.

In addition, the present invention provides an audio encoding/decoding apparatus having a watermark insertion/abstraction function and a method using the same, wherein, since the watermark is inserted into the encoded bit stream, it is possible to simply perform the watermark insertion and abstraction process with only slight increase in computational intensity.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A high sound-quality audio encoding apparatus comprising:
a bit allocation unit for allocating a bit to each sub-band using an SMR (Signal to Mask Ratio) value of each sub-band in an inputted audio signal;
a quantization unit for quantizing each sub-band sample in the inputted audio signal according to the number of bits allocated through the bit allocation unit;
a watermark insertion unit for inserting watermark data in a location of the quantized sub-band sample in the sub-band in which the bit is not allocated, and encoding the watermark-inserted sub-band sample; and
a bit stream generation unit for converting the quantized sub-band sample, the watermark-inserted sub-band sample, scale factor information and bit allocation information into a format of an audio bit stream, and transmitting the format-converted audio bit stream.

2. The audio encoding apparatus as set forth in claim 1, wherein, the quantization unit divides each sub-band sample in the inputted audio signal by a scale factor of the corresponding sub-band so that each sub-band sample is normalized, and quantizes the normalized sub-band sample.

3. The audio encoding apparatus as set forth in claim 1, wherein the watermark insertion unit sets the scale factor of the sub-band in which the watermark data are inserted, to 0 or a value close to 0.

4. The audio encoding apparatus as set forth in claim 1, wherein the watermark insertion unit allocates the bit according to the amount of watermark data which are required to be inserted into the corresponding sub-band when determining the sub-band into which the watermark data are inserted, and then inserts required watermark data of a binary bit stream into a location of the sub-band sample.

5. The audio encoding apparatus as set forth in claim 1, wherein, the bit stream generation unit separates the sub-band sample from the scale factor, and transmits the bit stream.

6. A high sound-quality audio decoding apparatus comprising:
a bit stream abstraction unit for abstracting a quantized sub-band sample, a watermark-inserted sub-band sample, bit allocation information and scale factor information from a compression-transmitted audio bit stream;
a watermark abstraction unit for abstracting watermark data from the watermark-inserted sub-band sample using the bit allocation information and scale factor information abstracted from the bit stream abstraction unit, and outputting the abstracted watermark;
a de-quantization unit for de-quantizing the quantized sub-band sample using the bit allocation information and scale factor information abstracted from the bit stream abstraction unit; and
a filter bank for converting the de-quantized sub-band sample though the de-quantization unit into a time-domain sample, and outputting a resulting decoded audio signal.

7. The audio decoding apparatus as set forth in claim 6, wherein, the watermark abstraction unit determines whether the watermark-inserted sub-band is present using a scale factor index in the abstracted scale factor information.

8. A high sound-quality audio encoding method comprising the steps of:
a) encoding an inputted audio signal into a plurality of sub-band samples, and allocating a bit to each sub-band;
b) quantizing each of the encoded sub-band samples according to the number of allocated-bits;
c) inserting watermark data in a location of the sub-band sample into which the bit is not allocated, among the quantized sub-band samples, and encoding the watermark-inserted sub-band sample; and
d) converting the quantized sub-band sample, the watermark-inserted sub-band sample, scale factor information and bit allocation information into a format of an audio bit stream, and transmitting the format-converted audio bit stream.

9. The audio encoding method as set forth in claim 8, wherein, said step a) allocates a bit to each sub-band using an SMR value of each sub-band.

10. The audio encoding method as set forth in claim 8, wherein, said step b) divides the encoded sub-band sample by a scale factor of the corresponding sub-band so that the encoded sub-band sample is normalized, and quantizes the normalized sub-band sample according to the number of allocated bit.

11. The audio encoding method as set forth in claim 8, wherein, said step c) sets the scale factor of the sub-band in which the watermark data are inserted, to 0 or a value close to 0.

12. The audio encoding method as set forth in claim 8, wherein, said step c) allocates the bit according to the amount of watermark data which are required be inserted into the corresponding sub-band when determining the sub-band into which the watermark data are inserted, and then inserts required watermark data of a binary bit stream into a location of the sub-band sample.

13. A high sound-quality audio decoding method comprising the steps of:
a) abstracting a quantized sub-band sample, a watermark-inserted sub-band sample, bit allocation information and scale factor information from a compression-transmitted audio bit stream;
b) abstracting watermark data from the corresponding sub-band using the bit allocation information of the sub-band in which the watermark data is inserted, and outputting the abstracted watermark;
c) de-quantizing the quantized sub-band sample using the bit allocation information and scale factor information of the corresponding sub-band; and
d) converting the de-quantized sub-band sample into a time-domain sample, and outputting a resulting decoded audio signal.

14. The audio decoding method as set forth in claim 13, wherein, said step b) determines the watermark data inserted sub-band using the scale factor information.

15. The audio decoding method as set forth in claim 14, wherein, said step b) determines whether the watermark data inserted sub-band is present using a scale factor index in the scale factor information.
